(19) United States
(12) Patent Application Publication
(10) Pub. No.: US 2006/0102668 A1
(43) Pub. Date: May 18, 2006

(54) Rotating storage device

(76) Inventor: James Schultz, Lake Zurich, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/119,317

(22) Filed: Apr. 29, 2005

Related U.S. Application Data
(60) Provisional application No. 60/566,315, filed on Apr. 29, 2004.

(51) Int. Cl. B60R 9/048

(52) U.S. Cl. 224/400

(57) ABSTRACT

A superstructure, rotatable device for providing a rotatable mount on the superstructure, and a storage device configured for attachment to the rotatable device are disclosed. The superstructure may be used with, for instance, a boat, and may be collapsible. The rotatable device and storage device may form a rack for mounting board-like objects on, for instance, a boat such that the items may be stored outboard of a passenger compartment, but may be rotated such that a user may select a position for the device for ingress and egress to and from the device.

### CROSS-REFERENCE TO RELATED APPLICATION(S)

The present application claims priority to Provisional Patent Application Ser. No. 60/566,315, filed Apr. 29, 2004, and titled “Rotating Board Rack,” the specification of which is incorporated herein by reference in its entirety

### FIELD OF THE INVENTION

The invention relates to the storage of items, particularly storage of board-like objects such as wakeboards, snowboards, or water skis, and more particularly storage of such items on a vehicle used with such items.

### BACKGROUND OF THE INVENTION

Common pastimes and sports include water sports where a person on a board, ski, or similar item is pulled along behind a boat while using a hydroplane effect generated by the speed of the towed person to allow the person to ride generally atop the surface of the water.

Nearly as common as it is to participate in such activities, the issue of storing a board, ski, or similar item presents itself. Historically, skis or the like were simply piled in a passenger area of a boat. The benefit of this was that the skis or boards were easily stored or accessed by a passenger. However, the detriment was that the boards and skis were underfoot and cumbersome, among other issues. In addition, bringing the items into the passenger area often meant bringing in items that would drain water in the cabin.

One solution to this problem has been to provide storage devices that allow the boards to be mounted outboard of the passenger compartment, or otherwise on the exterior of the boat. In this manner, dripping from the boards is directed out of the passenger area. In addition, the boards are not in the way of people in the boat.

However, the use of outboard storage is not necessarily simple. For instance, one typically has to reach around a structure to which the storage device is mounted in order to store or remove an item from the storage device. Furthermore, it is often simply awkward to reach a device mounted in such a manner. At times, this awkward nature requires a person to be careful and the boat being properly steadied.

Accordingly, there has been a need for an improved storage device.

### SUMMARY OF THE INVENTION

In accordance with one aspect of the present invention, a storage device for boards, skis, and the like is disclosed. The storage device may be moved or rotated between a first position and a second position. In the first position, the storage device is generally oriented towards a person for inserting or storing items, or items stored therein are generally disposed towards the interior or passenger area, or towards passengers in general. In the second position, the storage device is generally oriented such that the device and items therein are generally disposed away from passengers or the passenger compartment. Accordingly, a user may selectively position the device for use, such as for ingress and egress of the items to and from storage in the device.

In accordance with a further aspect of the present invention, a superstructure or tower including a storage device is disclosed. The storage device and superstructure may be joined or otherwise be integral with each other to provide storage and support.

In accordance with a still further aspect of the present invention, a collapsible superstructure or tower is disclosed.

### BRIEF DESCRIPTION OF THE DRAWINGS

In the drawings, FIG. 1 is a perspective view of an embodiment of a storage device and a superstructure including features of the present invention;

FIG. 2 is a side elevation view of the storage device of FIG. 1;

FIG. 3 is a top plan view of the storage device of FIG. 2;

FIG. 4 is a side elevation view of a central shaft of the storage device of FIG. 2.

### DESCRIPTION OF THE PREFERRED EMBODIMENTS

Referring initially to FIG. 1, a superstructure 10 and an apparatus for storing or mounting items in the form of storage device 12 are depicted with the storage device 12 secured to and forming a part of the superstructure 10. In use, the superstructure 10 is typically secured directly or indirectly to a deck or hull sides of a boat (not shown) so that boat passengers may pass below the central portion of the superstructure 10 and so that, oftentimes, the controls (not shown) of the boat are located below the superstructure 10. In this manner, a pilot (not shown) of the boat would be present below the superstructure 10 when operating the controls. When operating the boat, the pilot's ability to move within the superstructure 10 is preferably unhindered, as would be desirable for viewing the operational field of the boat including the water surface.

The superstructure 10 has a front support structure 14, a rear support structure 16, and a plurality of bridges 18 connecting the front support structure 14 and the rear support structure 16. In present embodiment, the front support structure 14 includes a front crossbar 15 spanning a pair of front support legs 20 secured to the boat by respective front anchors 22. As depicted, the front anchors 22 provide a particular mounting orientation between the front support legs 20 and a surface on the boat (not shown) that mates with a bottom surface of the front anchors 22.

The rear support structure 16 includes a rear crossbar 17 spanning a pair of rear support legs 24 secured to the boat by respective rear anchors 28. The rear anchors 28 include a pivoting joint such as hinge joint 32 formed between the rear support legs 24 and the rear anchors 28. The rear anchors 28 also include a bottom surface 30 mating with a surface on the boat (not shown).

So that the superstructure 10 is collapsible, each of the front support legs 20 includes a connection 34 that is preferably quickly and easily connected or disconnected so the front crossbar 15 and an upper portion 36 of each of the front support legs 20 may be separated from a lower portion 38 of each front support leg 20. Once separated, the lower portion of the front support leg 20 may be collapsed such as by being folded forward onto itself with a hinge 40. Furthermore, when separated, rear support legs 24 may rotate around the rear anchors 28 so that the rear support structure 16 and the portion of the front support structure 14 connected thereto by the bridges 18 may be lowered downward.

As depicted in FIG. 1, the superstructure 10 includes two storage devices 12, one on each of the depicted rear support legs 24. However, the superstructure 10 may be provided with a single storage device 12 or with several, and the storage devices 12 may be provided on front support legs 20 or on intermediate support legs (not shown). Broadly speaking, the storage device 12 need not be mounted on any portion of the superstructure 10, it is simply viewed as convenient to do so when such a superstructure 10 is present on the boat.

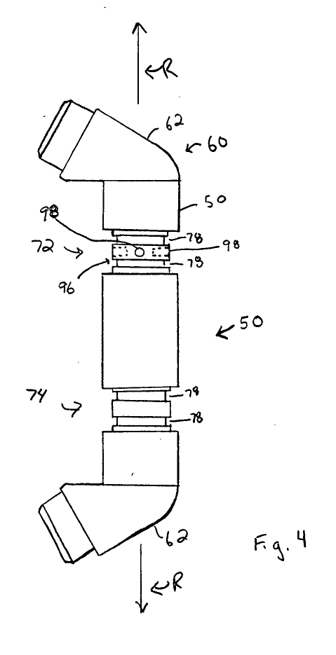

The depicted storage devices 12 are shown in a generally rearwardly facing position. As will be described below in further detail, the storage devices 12 may be moved between and to a plurality of positions, preferably by rotating about itself. To simplify such rotation, it is preferred that the storage device 12 rotate around a central shaft 50 (see FIG. 4) shared with the rear support leg 24 and, preferably, vertically oriented.

As shown in FIG. 1, each rear support leg 24 has an upper leg portion 52 and a lower leg portion 54, and the storage device 12 is located therebetween on the central shaft 50. In the depicted embodiment, the central shaft 50 is generally vertical while the balance of the rear support structure 16 is not vertical. It should be noted that the upper leg portion 52 and lower leg portion 54 may form a single piece with the storage device 12 mounted thereon, may form a plurality of pieces joined together, or may have other portions generally vertical. Furthermore, the storage device 12 may include an adapter portion mountable around a non-vertical portion such that the adapter forms the vertical central shaft 50.

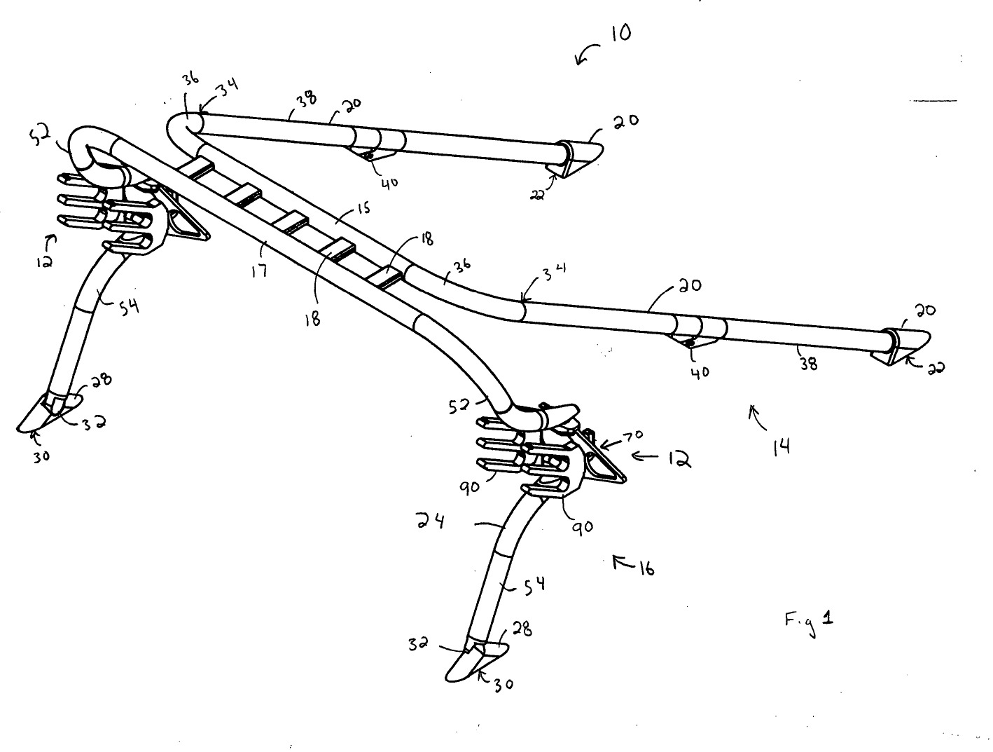

As shown in FIG. 2, the central shaft 50 is integral with a mount section 60 wherein the mount section 60 is either integral with or joinable to the upper and lower leg portions 52, 54 by connections 62. As much of the superstructure 10 is formed of tubular material such as steel, the connections 62 are cylindrical for being received with an end of the upper or lower leg portions 52, 54, though the configuration may reversed and many other types of connections may used. Each connection 62 is oriented in a direction, represented by arrows C1 and C2, generally along a center line of the portion 52, 54 of the rear support structure 16 to which the connection 62 is secured. As can be seen, the central shaft 50 has an axis of rotation R through its center, the axis R being generally vertical as above-described. As can also be seen, arrows C1 and C2 have a skew orientation relative to the axis R.

The connections 62 are secured to the central shaft 50 with, for instance, bolts 66, presently depicted as being driven through recess 68 aligned with the axis R. A pair of pegs 69 is used at the junction between the connection 62 and the central shaft 50 to ensure proper orientation between therein when secured. In order to provide a storage device 12 for various superstructures where the direction, such as C1, C2, of the adjoining portion of the superstructure similarly vary, the only components that need be changed or altered are the connections 62. That is, the superstructure may not be tubular, may have an opening with a different gauge size to meet with the mount section 60, or may have joining members (upper and lower leg portions 52, 54) at a different angle from axis R than those depicted by directions C1, C2. In this case, connection 62 with an mismatched configuration may simply be removed from the central shaft 50 and replaced with another that is properly configured for that superstructure.

The storage device 12 includes a body 70 that is secured to and rotates around the central shaft 50. The body 70 may be rotatably secured to the central shaft 50 to form one or more bearings such as top bearing 72 and bottom bearing 74. Use of the top and bottom bearings 72, 74 distributes torque due to items stored in the device 12 items through the central shaft 50 and the superstructure itself.

For each bearing 72, 74, the body 70 includes a pair of half-cylinders such that the pair, when joined, form a cylindrical outer bearing portion 76. An inner surface of the outer bearing portion 76 includes grooves wherein the grooves contact similar mating grooves 78 on the central shaft 50 (see FIG. 4). The surfaces between the grooves of the outer bearing portion 76 and the grooves 78 of the central shaft 50 may be formed of or covered by a low-friction material, such as nylon or delrin, or may be lubricated such as with a material suitable for marine lubrication applications. The body 70 further includes a frame 80, which in the presented embodiment includes two half-frames 82 where each is secured to the outer bearing portions 76. A representational rack 90 is shown secured to the frame 80 (see FIG. 1) as at securements 92 (see FIG. 2). The rack 90, as depicted, is designed to receive board-like objects such as skis or wakeboards.

As discussed above, the storage device 12 maybe provided with a plurality of positions. As can be seen in FIG. 4, the portion of the central shaft 50 forming the top bearing 72 includes a portion 96 with ports or holes 98, each hole 98 corresponding to a particular position. In the present embodiments, the holes 98 are located every 90° such that the holes 98 correspond to a forward, rearward, inboard, or outboard position to which the storage device 12 may be rotated. It should be noted that number and orientation of the holes 98 may be varied to provide for more or different positions for the storage device 12.

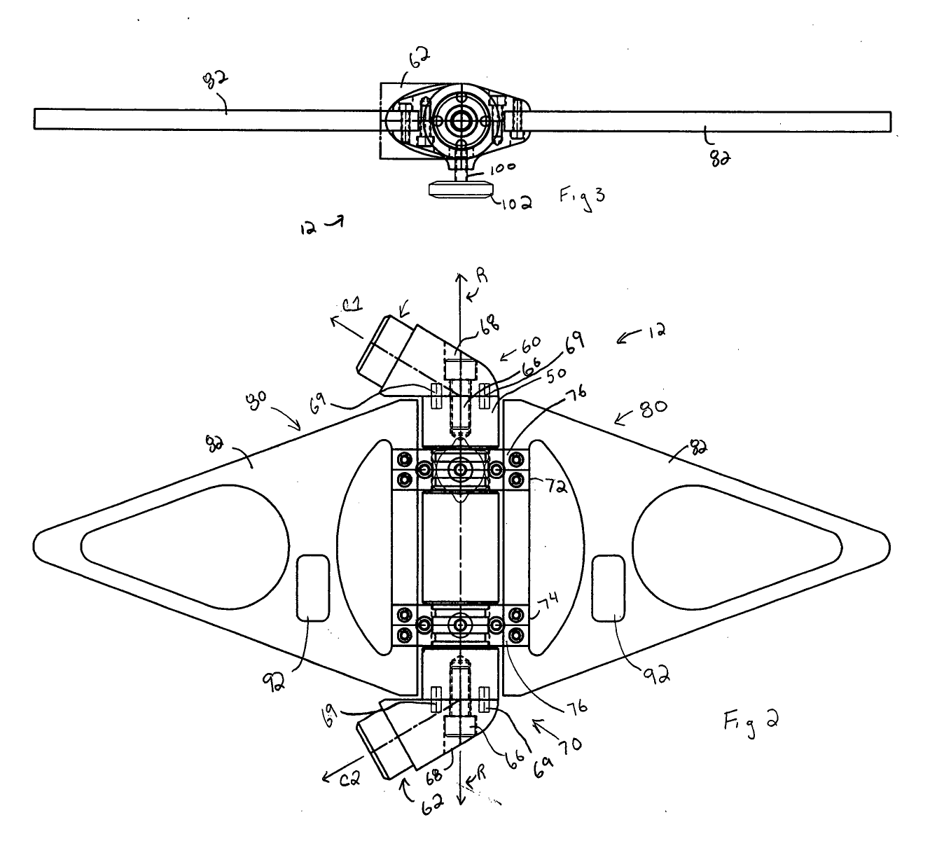

The storage device 12 may be rotated around the central shaft 50, as has been discussed, and positioned according to the holes 98. More specifically, the outer bearing portion 76 of the top bearing 72, for instance, may have a spring-loaded pin 100 mounted on a knob 102, as can be seen in FIG. 3. The pin 100 is spring-biased to an interfering or locking position with the holes 98. That is, when the storage device 12 is rotationally positioned such that the pin 100 is aligned with a hole 98, the pin 100 is spring-biased into the hole 98 such that the storage device 100 is prevented from further rotation. In order to allow the storage device 12 to rotate, the knob 102 is pulled outward, thereby counter-biasing the pin 100 so that the pin 100 retracts from the hole 98 and, thus, the storage device 12 is released such that the storage device 12 may be rotated. In addition, the portion 96 of the central shaft 50 may include surface features for directing the pin 100 towards the holes 98. For instance, the region laterally proximate each hole 98 may be generally flat transversely to the direction of the hole 98 or be recessed such that a spring-biased pin 100 contacting the proximate region is directed towards the hole 98. Additionally, such a configuration would allow an operator to feel when a pin 100 that is not located in a hole 98 but is contacting the proximate region is moving towards or away from a hole 98 based on the resistance to rotation of the storage device 12.

It should be noted that the present embodiments have been described principally in reference to a boat. However, the storage device and/or superstructure could be used with another vehicle or structures, such as off-road vehicles, snowmobiles, or rigging such as scaffolding. Furthermore, the storage device describes a rotatable mount which may be adapted for uses other than a storage device with a rack 90, such as rotatably mounting a light, a speaker, a camera, or many other implements.

While the invention has been described with respect to specific examples including presently preferred modes of carrying out the invention, those skilled in the art will appreciate that there are numerous variations and permutations of the above described systems and techniques that fall within the spirit and scope of the invention.

1. An apparatus for securing items, the apparatus comprising:
a central portion;
an upper bearing and a lower bearing operably coupling the central portion to a portion of a support structure and permitting the apparatus to rotate relative to the support structure portion; and
a body portion for securement of the items.

2. The apparatus of claim 1 wherein the body portion includes a frame for receiving items for securement.

3. The apparatus of claim 1 wherein the body portion permits securement of items thereto.

4. The apparatus of claim 1 wherein the apparatus may be substantially locked in at least a first position.

5. The apparatus of claim 4 further including a biased locking member, a receptacle for each locked position, the position of the apparatus being substantially locked by receipt of the locking member within one of the receptacles.

6. In combination with a superstructure on a boat, an apparatus for securement of items, the apparatus comprising:
a central portion;
an upper connection for securing the central portion to an upper portion of the superstructure;
a lower connection for securing the central portion to a lower portion of the superstructure, the upper and lower connections being positioned to allow rotation of the central portion about the upper and lower portions of the superstructure; and
a body portion for securement of the items.

7. The combination of claim 6 wherein each of the upper and lower connections have first and second portions positionable about the upper and lower portions of the superstructure, the first and second portions being joined to secure the connections to the superstructure.

8. The combination of claim 6 wherein the upper and lower portions of the superstructure include a respective upper terminus and lower terminus, and the apparatus is securable to and between the upper terminus and lower terminus.

9. A superstructure for a boat, the superstructure comprising:
an extending portion secured relative to a deck of the boat, the extending portion having a first mounting portion and a second mounting portion;
an apparatus for securement of items, the apparatus rotatable relative to the extending portion; and
an upper bearing and a lower bearing mountable to the extending portion mounting portions for operably coupling the apparatus to the extending portion.

10. The superstructure of claim 9 wherein the bearings are securable around the mounting portions.

11. The superstructure of claim 10 wherein the mounting portions and bearings include cooperating bearing surfaces and grooves providing for relative motion therebetween.

12. The superstructure of claim 9 further including a body portion, wherein the mounting portions each include a terminus, the apparatus is secured to each terminus, and the bearing portions permit relative motion between the body portion and each terminus.

13. The superstructure of claim 9 wherein the apparatus is lockable in at least a first position relative to the extending portion.

14. The superstructure of claim 13 further including a receptacle for each lockable position, wherein the apparatus includes a biased pin, and the apparatus being positionable relative to each receptacle to permit the biased pin to be received in a receptacle to lock substantially the position of the apparatus relative to the extending portion.
